(19) United States
(12) Patent Application Publication
(10) Pub. No.: US 2010/0105381 A1
(43) Pub. Date: Apr. 29, 2010

(54) RADIO COMMUNICATION TERMINAL AND IN-CELL RETURN PROCESSING METHOD

(75) Inventor: Hiroshi Takeda, Yokohama-shi (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/529,013

(22) PCT Filed: Feb. 27, 2008
(86) PCT No.: PCT/JP2008/053446

§ 371 Date: Nov. 10, 2009

(30) Foreign Application Priority Data
Feb. 27, 2007 (JP) 2007 048128

(51) Int. Cl. H04W 48/20

(52) U.S. Cl. 455/434

(57) ABSTRACT

To provide a radio communication terminal which can effectively acquire a communication system as an in-cell return process which scans and detects a base station enabled for communication when a transmission operation is performed even if a radio communication terminal compatible with a plurality of communication methods is out of a cell, and which can try a connection with a base station by a communication method desired by a user. A control part (8) detects that a mobile telephone (100) is in an out-of-cell state and decides the scan order of a base station enabled for communication according to Nlist (a list created according to base stations in the neighborhood) which has been updated immediately before the mobile telephone (100) enters the out-of-cell state upon an in-cell reset process for returning to the in-cell state (wait state).

### TECHNICAL FIELD

The present invention relates to a wireless communication terminal suitable for use in a multiband compatible communication system and a signal processing method of the same.

More specifically, the present invention relates to an in-area reset processing technique of a wireless communication terminal.

### BACKGROUND ART

When a wireless communication terminal applied to CDMA (Code Division Multiple Access) communication or other wireless communication is ready for a call at a base station under a good condition but the strength of a signal received from a base station becomes degraded, a wireless communication terminal attempts handover to another base station. However, if there is no other base station with a strength enabling the communication to receive a call and the signal from the base station being communicated with becomes further weaker to a level where the signal can no longer be acquired, the wireless communication terminal judges that the terminal is in an out-of-service-area state.

Further, in a state judged out of area, a wireless communication terminal performs in-area reset and acquirement processing for “in-area” reset preparing for a case where the signal conditions around the terminal subsequently change or the terminal moves and a signal can be acquired again. Specifically, the terminal enters a system scan state where the terminal repeatedly tries to acquire a frequency where the terminal can wait for a call by a predetermined cycle and searches for base stations.

As an example of an acquirement operation of a channel for such in-area reset processing in a predetermined cycle, there is the following document (Patent document 1).

PLT 1: Japanese Patent Publication (A) No. 2004-15312

### DISCLOSURE OF THE INVENTION

### Problem to be Solved by the Invention

When a wireless communication terminal is out of area as explained above, the wireless communication terminal internally turns on (sets) a flag showing the terminal is “out of area” (out-of-service-area flag). In such a situation, even if the user of that wireless communication terminal performs a send operation, the terminal will not start up the send processing while the out-of-service-area flag is ON.

Due to the above, in wireless communication terminals able to handle a plurality of communication systems, it has been desired to provide a wireless communication terminal capable of efficiently capturing a communication system when a send operation is performed even when the terminal is in a state judged out of area and attempting connection according to the communication scheme desired by the user as much as possible.

### Means for Solving the Problem

According to the present invention, there is provided a wireless communication terminal for establishing in wireless communication with one base station among a plurality of base stations, the wireless communication terminal having: a communication part which selects one base station of a communication system with one frequency band among a plurality of communication systems with frequency bands available to this wireless communication terminal and engages in wireless communication with the terminal; and a control part which performs acquirement processing on the available plurality of communication systems through the communication part in a state judged as an out-of-service-area state in which the wireless communication terminal cannot communicate and performs in-area reset processing so as to start position registration processing at one base station using one communication system which could be acquired during which it sets an acquirement sequence of communication systems based on neighbor base station information showing information concerning neighboring base stations which had been acquired by the communication part from base stations for which wireless communication had been established before the wireless communication terminal shifted out of area.

Preferably, the control part determines the acquirement sequence of communication systems in accordance with a quantity of base stations using communication systems included in the neighbor base station information.

Further, preferably, the wireless communication terminal of the present invention can employ any of the aspects described below:

(1) in a case where there are a plurality of base stations using the acquired communication systems, the control part determines the acquirement sequence of base stations using the acquired communication systems in accordance with a magnitude of a received signal strength for each base station measured by the communication part before the wireless communication terminal shifted out of area;

(2) the wireless communication terminal further has a memory part holding information identifying base stations specified by the neighbor base station information, and, when there are a plurality of base stations using the acquired communication systems, the control part determines the acquirement sequence of base stations using the acquired communication systems in accordance with relative age of the times at which the memory part held the information specifying the base stations; and

(3) when there are a plurality of base stations using the acquired communication systems, the control part determines the acquirement sequence of the base stations based on information concerning the relative length of correlation attempt periods of spread spectrum codes included in the neighbor base station information.

Further, according to the present invention, there is provided an in-area reset processing method of a wireless communication terminal establishing in wireless communication with one base station among a plurality of base stations, the in-area reset processing method of a wireless communication terminal performing acquirement processing on an available plurality of communication systems through a communication part in a state judged as an out-of-service-area state in which the wireless communication terminal cannot communicate and performing in-area reset processing so as to start position registration processing at one base station using one communication system which could be acquired during which setting an acquirement sequence of communication systems based on neighbor base station information showing information concerning neighboring base stations which had been acquired by the communication part from base stations for which the wireless communication had been established before the wireless communication terminal shifted out of area.

Further, according to the present invention, there is provided a wireless communication terminal including a communication part and a control part and establishing in wireless communication with one base station among a plurality of base stations, the wireless communication terminal characterized in that the communication part is configured to select one base station of one communication system among a plurality of communication systems available to the wireless communication terminal and engage in wireless communication with it, and the control part is configured to perform acquirement processing on the available plurality of communication systems through the communication part in a state judged as an out-of-service-area state in which the wireless communication terminal cannot communicate and performs in-area reset processing so as to start position registration processing at one base station using one communication system which could be acquired during which the control part sets an acquirement sequence of communication systems based on neighbor base station information showing information concerning neighboring base stations which had been acquired by the communication part from base stations for which wireless communication had been established before the wireless communication terminal shifted out of area.

### EFFECTS OF THE INVENTION

According to the present invention, it becomes possible to efficiently acquire available communication systems when a send operation is performed even in a state where the wireless communication terminal is judged to be out of area without increasing power consumption in the wireless communication terminal and to attempt connection with a base station according to a communication scheme desired by the user as much as possible.

### BRIEF DESCRIPTION OF DRAWINGS

FIG. 1 is a block diagram showing the internal configuration of a mobile phone as an example of a wireless communication terminal of the present invention.

FIG. 2 is a view showing an example of an appearance of the mobile phone.

FIG. 3 is a flow chart for explaining an operation at the time of an in-area reset processing of the mobile phone.

FIG. 4 is a view showing an example of an Nlist.

### EXPLANATION OF NOTATIONS

100 . . . mobile phone, 101 . . . upper housing, 102 . . . lower housing, 103 . . . hinge part, 1 . . . communication part, 2 . . . operation part, 3 . . . audio processing part, 4 . . . speaker, 5 . . . microphone, 6 . . . display part, 7 . . . memory part, and 8 . . . control part.

### BEST MODE FOR CARRYING OUT THE INVENTION

Below, the basic technology for when explaining embodiments of the present invention will be explained.

A wireless communication terminal used for CDMA (Code Division Multiple Access) communication or other wireless communication starts an acquirement operation of available communication systems when the power is turned ON or the like.

Here, the “communication system” designates a wireless communication path multiplexed according to a frequency, timing, or code in an available communication scheme of the wireless communication terminal.

In particular, in a CDMA 2000_{—}1x scheme, first, position registration processing is carried out in a communication system which can be acquired after the power of the wireless communication terminal is turned on.

Namely, the wireless communication terminal stores in advance frequency information which it can handle and measures the received signal strength of that frequency. When a signal strength more than a predetermined level is detected, existence of a pilot channel at this frequency is confirmed, the pilot channel is synchronized with using as the spread spectrum code, for example, a pseudo noise (PN) code to obtain a synchronized channel, and the base station information (for example, PN code offset) is obtained. Further, the terminal specifies base stations having good communication conditions, registers their positions, and enters into a call ready state.

When despite waiting for a call in this way the signal strength of the signal received from the base station is degraded, the wireless communication terminal attempts handover to another base station. However, when even when the terminal tries handover to another base station, there is no other base station having a signal strength strong enough for the terminal to wait for a call and the signal from the base station being communicated with at present becomes further weaker to a level that a signal can no longer be acquired, the wireless communication terminal judges that the terminal has fallen into an out-of-service-area state in which the terminal cannot communicate with a base station.

The wireless communication terminal performs an in-area reset acquirement operation for in-area reset preparing for a case where the signal conditions around the terminal subsequently change or the terminal moves and a signal can be acquired again.

Specifically, the wireless communication terminal enters a system scan state where the terminal repeatedly tries to acquire a frequency where the terminal can wait for a call by a predetermined cycle and searches for base stations.

Then, once judged “out of area”, the wireless communication terminal performs the in-area reset processing by a predetermined cycle, but the communication schemes for attempting scan of communication systems for reset are limited and the time required for “in-area” reset can no longer be ignored.

The wireless communication terminal of an embodiment of the present invention solves this problem.

Below, as an example of a wireless communication terminal of the present invention, a mobile phone 100 will be explained.

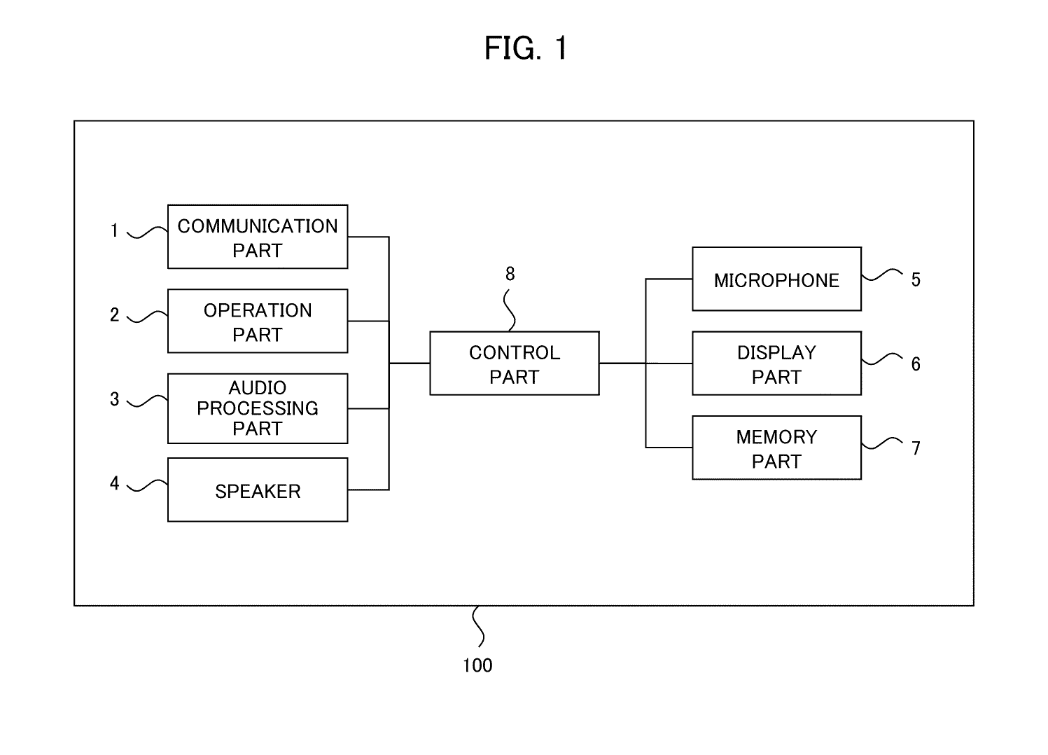

FIG. 1 is a block diagram showing the internal configuration of the mobile phone 100. As shown in FIG. 1, the mobile phone 100 has a communication part 1, operation part 2, audio processing part 3, speaker 4, microphone 5, display part 6, memory part 7, and control part 8.

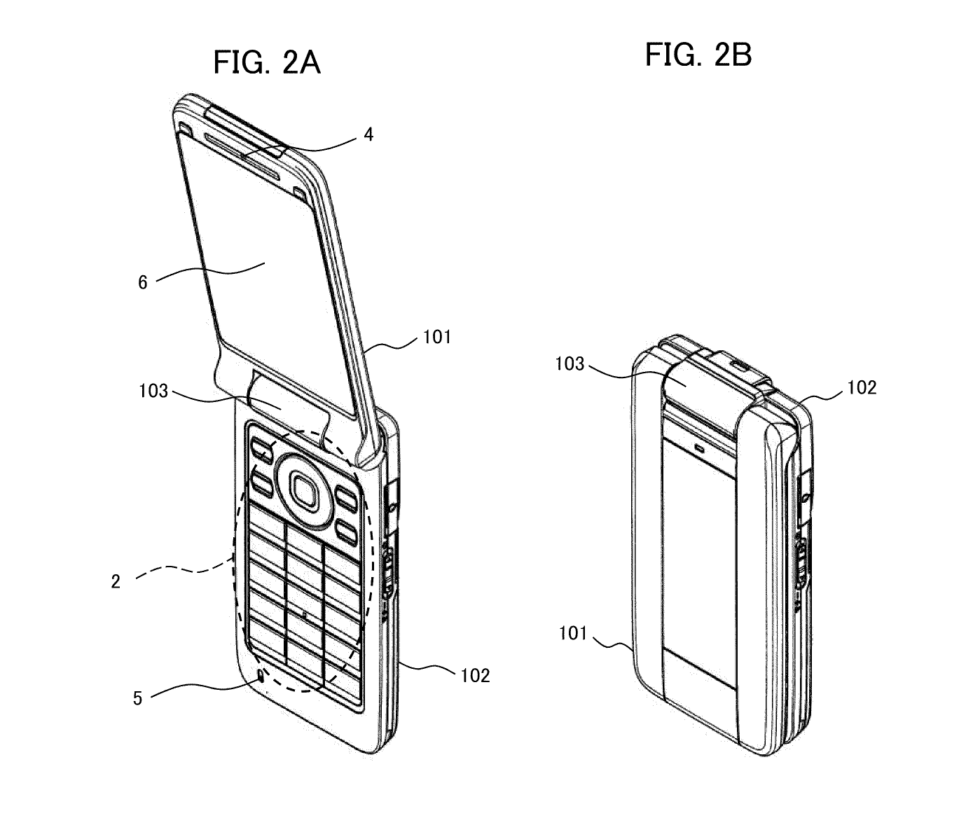

FIG. 2 is a view showing an example of the appearance of the mobile phone 100.

As shown in FIG. 2, the mobile phone 100 is formed by an upper housing 101 and a lower housing 102 which are connected to each other by a hinge part 103 so that the phone can be opened/closed.

FIG. 2A shows a state where the housings of the mobile phone 100 are opened, and FIG. 2B shows a state where the housings of the mobile phone 100 are closed.

The upper housing 101 has the speaker 4 and display part 6.

The lower housing 102 has the microphone 5 and operation part 2. Further, in the lower housing 102, the communication part 1, audio processing part 3, memory part 7, and control part 8 are accommodated in its inside.

The communication part 1 uses a communication channel assigned by any of the plurality of base stations and connects with this base station through a not shown antenna. This communication part 1 can transmit and receive wireless signals by any frequency band among a plurality of frequency bands.

The plurality of frequency bands illustrated here are one example of the bands in Japan. Specifically, these are the existing frequency band (old 800 MHz band), new frequency band (new 800 MHz band), and high frequency band (2 GHz band).

The above communication systems using different frequency bands are assigned codes called “band classes” prescribed by the 3GPP2 (3rd Generation Partnership Project 2) as identification numbers for the base stations and the mobile phone to identify the frequency bands. For example, in a list of neighboring base stations (Neighbor List) etc. in information informed from one base station to the mobile phone, these band classes are used for reporting the base stations existing around the mobile phone to the mobile phone and so on.

Note that, the existing frequency band (old 800 MHz band) is classified as the “band class 3”, the new frequency band (new 800 MHz band) is classified as the “band class 0”, and the high frequency band (2 GHz band) is classified as the “band class 6”.

The communication part 1 performs the in-area reset processing under the control of the control part 8 explained later when detecting that the mobile phone 100 is out of area. The in-area reset processing will be explained in detail later.

The operation part 2 has, for example, a power key, speak key, number keys, letter keys, direction keys, an execute key, a send key, and other keys to which various functions are assigned. When these keys are operated by the user, the operation part 2 generates signals corresponding to those operation contents and inputs these as an instruction of the user to the control part 8.

The audio processing part 3 performs the processing of the audio signal output from the speaker 4 and audio signal input at the microphone 5. Namely, the audio processing part amplifies audio input from the microphone 5, performs analog-to-digital conversion, and further applies encoding or other signal processing to the audio signal converted to digital to convert the audio signal to digital audio data and outputs the result to the control part 8. Further, the audio processing part 3 applies decoding processing, digital-to-analog conversion processing, amplification processing, or other signal processing to the audio data supplied from the control part 8 to convert the audio data to an analog audio signal and outputs the result to the speaker 4.

The display part 6 is configured by using, for example, a liquid crystal display panel, an organic EL (Electro-Luminescence) panel, or other display device and displays an image in accordance with a video signal supplied from the control part 8. For example, the display part 6 displays a phone number of a destination at the time of a send operation, a phone number of the other party at the time of the reception, contents of received mail and transmitted mail, the date, time, remaining battery power, success of a send operation, a standby screen, and other various information and images.

The memory part 7 stores various types of data utilized for various types of processing of the mobile phone 100. The memory part 7 holds, for example, programs of a computer provided in the control part 8, an address book for managing personal information such as phone numbers and e-mail addresses of other parties, an audio file for playing back an incoming call sound and an alarm sound, an image file for the standby screen, various types of setting data, temporary data utilized in the processing process of the programs, and so on. Note that, the above memory part 7 is configured by, for example, a nonvolatile memory device (nonvolatile semiconductor memory, hard disc device, optical disc device, etc.), a random accessible memory device (for example, SRAM or DRAM), or the like.

The control part 8 centrally controls the entire operation of the mobile phone 100. Namely, the control part 8 controls operations of blocks configuring the mobile phone 100 explained above (for example, transmission/reception of signals at the communication part 1, input/output of audio at the audio processing part 3, display of an image in the display part 6, and so on) so that various types of processing of the mobile phone (speech carried out through a channel exchange network, preparation and transmission/reception of e-mails, viewing of Internet Web (World Wide Web) sites, and so on) are executed in a suitable sequence in accordance with the operation of the operation part 2.

The control part 8 is provided with a computer (for example, microprocessor) executing processing based on a program (for example, operating system or application program) stored in the memory part 7 and executes the processing explained above according to the sequence instructed in this program. Namely, the control part 8 provided with a computer sequentially reads command codes from the operating system, application program, or other program stored in the memory part 7 to execute the processing.

The control part 8 performs various types of communication processing for controlling the communication part 1 and making it engage in wireless communication with a not shown base station. Further, the control part 8 scans the many base stations in the out-of-service-area state and finds a base station which can be wirelessly communicated with.

The control part 8 performs the following operation when the communication is started by turning on the power of the mobile phone 100 or the like.

Signal Strength Measurement, Synchronization, Change of Setting of Parameters, Call Ready Processing

The control part 8 measures the received signal strengths of a plurality of frequency bands according to a PRL (Preferred Roaming List) stored in advance in the memory part 7.

The PRL is a list storing information for communication paths of all frequency bands which can be acquired by the wireless communication terminal (band classes and frequency bands, primary/secondary channel identifiers, used channel specifying codes, etc.) therein.

When detecting that the received signal strength of a frequency band in the PRL is a predetermined level of strength or more, the control part 8 recognizes the existence of a pilot channel at that frequency band. When the pilot signal is acquired, the control part 8 finds the correlation between a reference PN code used as a spread spectrum code from the base station and a replica PN code prepared by the control part 8 to establish synchronization and thereby acquires a synchronized channel from the base station. When a synchronized channel can be established, the control part 8 acquires the overhead information in a paging channel and changes settings of parameters for receiving the paging channel based on the acquired overhead information.

In this way, the control part 8 can discriminate with which base station in the PRL it can communicate with, performs position registration processing for a base station with a good communication condition(s) (the signal strength of the pilot channel is strong or the like), establishes communication with the base station, and enters into a call ready state (in-area state).

Reception of Neighbor List and Hand-Off Processing

In the “in-area” state, the control part 8 receives the neighbor base station information (Neighbor List) from the base stations being communicated with. Then, the control part 8 generates a search list for hand-off based on the received Neighbor List and performs hand-off processing based on this.

Specifically, in a state currently able to communicate with base stations as a call ready state, the control part 8 refers to the search list at each predetermined cycle to judge whether or not hand-off is required. In particular, when generating a search list, the control part 8 forms a list in which the PN codes matching with the first frequency band being used at present in a group of the PN codes notified in the Neighbor List are located at the top and the remaining PN codes belonging to the second frequency band (that is, codes having different band classes, primary/secondary frequency) are located at the bottom. Due to this, at an intermittent hand-off judgment by the predetermined cycle, the control part 8 first measures the strength of the pilot channel for the higher PN codes. If there is a PN code capable of obtaining a good pilot channel strength, the control part performs a soft hand-off to a base station corresponding to this. If there is no PN code capable of soft hand-off, the control part searches through the remaining lower PN codes, that is, the PN code for which a second frequency band different from the first frequency band being used at present is designated, and judges whether or not a hard hand-off is possible. When hard hand-off is possible, the control part switches the frequency of the communication part 1 from the frequency being used at present to search for a channel capable of communication, and executes the hard hand-off processing.

Further, the control part 8 stores information concerning the communication systems (band classes, primary or secondary, PN) acquired through the communication part 1 in the memory part 7 at the time of the “in-area” state (call ready state). Namely, the control part 8 stores the communication systems which can be acquired as an acquirement history (MRU information: Most Recently Used information: corresponding to acquire history information of the present invention) in the memory part 7 when any communication system can be acquired.

Note that, in the MRU information, as the acquirement history of communication systems, not only information concerning the newest single communication system successful in acquirement, but also information specifying several communication systems by an FIFO (First-In First-Out) method (band classes, frequencies, primary/secondary, channel identifiers, protocol identifiers, codes specifying used channels, etc.) are included in an order of success of acquisition. This MRU information is stored in the memory part 7.

The control part 8 performs the in-area reset processing through the communication part 1 when the mobile phone 100 is out of area.

Below, the in-area reset processing will be explained in detail.

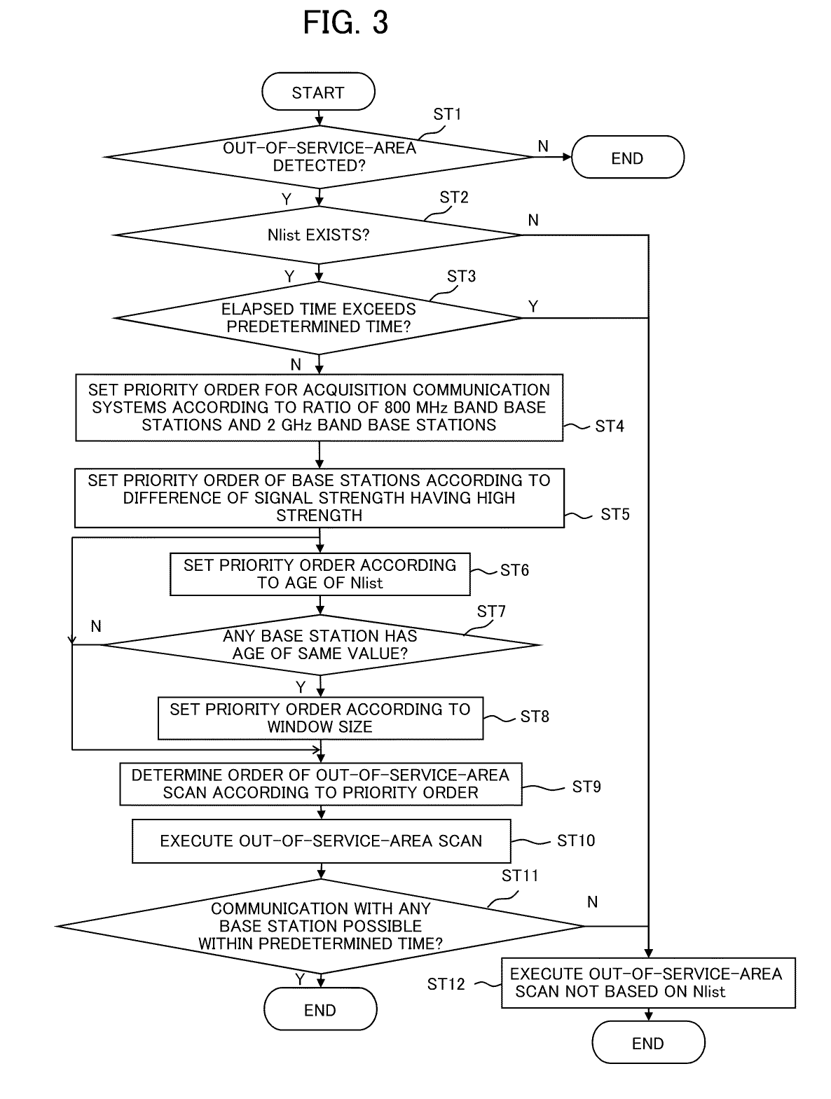

FIG. 3 is a flow chart for explaining the operation of the mobile phone 100 at the time of the in-area reset processing.

In FIG. 3, base stations which can be communicated with by the mobile phone 100 are, for example, the base stations with the 800 MHz band and the base stations with 2 GHz band.

Step ST1

The control part 8 detects whether or not the mobile phone 100 is in an out-of-service-area state through the communication part 1.

The term “out-of-service-area state” in the present embodiment is the state where a signal having a strength strong enough for communication is no longer detected from any communication system and the state where the acquirement processing of communication systems for the in-area reset is intermittently executed by a predetermined cycle, but the mobile phone 100 has not been able to achieve “in-area” reset enabling communication with a base station.

Note that, as the method of detection of “out of area”, various existing techniques can be utilized. In the present invention, the “out of area” detection method itself is not limited.

When the out-of-service-area state is judged, the routine proceeds to step ST2, while when not the out-of-service-area state is judged, the processing is ended.

Step ST2

The control part 8 judges whether or not the control part has an Nlist.

An Nlist is information concerning the neighboring base stations which is prepared by the control part 8 based on the neighboring base station list Neighbor List obtained from a base station being communicated with and stored in the memory part 7 before the mobile phone 100 entered the out-of-service-area state, that is, at the time of the in-area state (call ready state) when the mobile phone 100 was communicating with a base station. The Nlist is obtained by acquiring, for example, spread spectrum codes supported by the neighboring base stations (identification codes given for each of the base stations), for example, pseudo noise (PN) codes, band classes, window sizes etc. from the Neighbor List.

The window size is a value showing the length of a correlation attempt time of the PN codes used as the spread spectrum codes between a base station and the mobile phone 100 and shows a duration of monitoring a code train on the pilot channel of the PN codes. The PN codes are a very long code train, therefore a very long time is taken for searching through all of the code train. For this reason, in the present embodiment, the duration of searching for the pilot channel by the window size is limited to a proper duration. Note that, the larger the window size, the longer the time required for searching. However, a possibility of detection of a signal becomes high.

When the communication part 1 is in the in-area state (call ready state) in which communication with a base station is possible, the information Neighbor List concerning the neighboring base stations of that base station is transmitted from the base station to the mobile phone 100. The control part 8 receives the Neighbor List through the communication part 1 and stores the List in the memory part 7.

The Neighbor List is the information transmitted by a base station for soft hand-off when moving out of the range of the base station being communicated with at present etc. (change to communication with a base station having a larger received signal strength of communication than that at present in a case where the received signal strength of communication with the base station being communicated with at present, that is, the signal strength of the pilot signal of the PN codes, is a predetermined value or less or lower than the signal strength of communication with another base station in the Neighbor List),

When receiving the Neighbor List, the control part 8 simultaneously measures the signal strength of the pilot channel of each PN code in the Neighbor List through the communication part 1 and stores it in the memory part 7 linked with the Neighbor List.

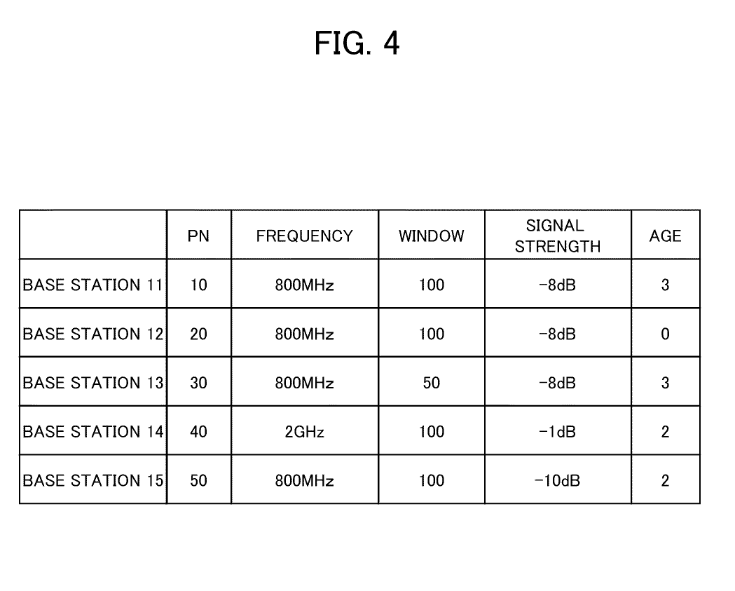

FIG. 4 is a view showing an example of an Nlist. The values shown in FIG. 4 are one example.

In FIG. 4, “PN” represents the pseudo noise (PN) of the neighboring base stations, “frequency” represents the communication channel (frequency band) (unit: Hz) of a base station, and “window” represents the window size. In the Nlist, “PN”, “frequency”, and “window” are data acquired from the Neighbor List obtained from the base stations being communicated with. The “signal strength” shows the strength (signal strength) of the pilot channel of the PN code of each base station which was measured by the communication part 1 under the control of the control part 8. The “AGE” is the value representing the age of information in the Nlist.

The communication part 1 obtains a new Neighbor List from the base stations each predetermined time or at each hand over, compares the information in the new Neighbor List with the Nlist, and sets the value of the “AGE”. Namely, when there is the same base station as a base station in the Nlist in the newly obtained Neighbor List, the information concerning that base station is updated, and the value of “AGE” is set to “0”. Further, when there is information of a base station which does not exist in the Nlist in the new Neighbor List and communication with a new base station is possible, the value of “AGE” is set to “0” in the information concerning the new base station (“PN”, “frequency”, and “window” acquired from the Neighbor List and the “signal strength” measured by the communication part 1) and the information is added to the Nlist. When a base station in the Nlist does not exist in the newly obtained Neighbor List, the value of “AGE” of the Nlist is incremented by exactly “1” (other items not changed).

By setting the value of “AGE” in the Nlist as described above, it is learned up to how long ago the base station corresponding to that value of “AGE” could be communicated with. Namely, for a base station existing in the newest Neighbor List and which could be communicated with, the value of “AGE” in the Nlist will always be “0”. The value of “AGE” for a base station which does not exist in the newest Neighbor List or which does but could not be communicated with is incremented by one whenever the Neighbor List is updated. After the mobile phone 100 becomes an out-of-service-area state, the Neighbor List is no longer updated, therefore the value of “AGE” will always become “0” for a base station which could be communicated with up to immediately before the time when the mobile phone 100 moved to the out-of-service-area state.

In this way, the closer the value of “AGE” to “0”, the most recently communication had been possible with the base station. Note that, when a value of “AGE” becomes larger than a predetermined threshold value AGE max, the information concerning that base station may also be deleted from the Nlist. This is because a base station which could be communicated with a predetermined time before is not always easy to communicate with at present.

At step ST2, the control part 8 judges whether or not there is an Nlist (and signal strengths linked with PN codes in the Nlist) in the memory part 7, proceeds to step ST3 where there is, and proceeds to step ST12 where there is not.

Step ST3

The control part 8 judges whether or not the time elapsed from when an Nlist confirmed to exist at step ST2 was updated to the present time exceeds a predetermined time, for example, 1 hour, proceeds to step ST12 where the time exceeds the predetermined time, and proceeds to step ST4 where the time does not exceed the predetermined time.

Due to this, when the Nlist stored in the memory part 7 is information old to a certain extent or more, the “out of area” processing is carried out without using the old Nlist as it may be very different from the communication situation at present, therefore the possibility of shortening the time required for the in-area reset processing becomes higher than the case where the in-area reset processing is carried out by using the old Nlist.

Step ST4

The control part 8 refers to the Nlist stored in the memory part 7 to find, for example, the ratio between the number of base stations with the 800 MHz band and the number of base stations with the 2 GHz band. For example, in the example of the Nlist shown in FIG. 4, (number of base stations with 800 MHz band):(number of base stations with 2 GHz band)=4:1.

The control part 8 determines the priority order of scanning of the communication systems so as to scan for acquisition from the communication system having the largest number of base stations. Namely, in the example of the Nlist shown in FIG. 4, the control part 8 sets the order of priority of scanning high for the base stations with the 800 MHz band, that is, sets the priority order of scanning so that the priority order for the base stations with the 2 GHz band becomes lower than the base stations with the 800 MHz band.

Note that, in a case where the ratio between the number of the base stations with the 800 MHz band and the number of the base stations with the 2 GHz band is 1:1, the routine proceeds to step ST5 without setting the priority order at step ST4.

Further, when the ratio of the numbers of base stations becomes a certain constant or more (case where the difference between the number of base stations with 800 MHz band and the number of base stations with 2 GHz band is very large, for example, 1:30), the scanning of the communication systems with the smaller number of base stations may be suspended, and only scanning of communication systems having the larger number of base stations carried out.

Step ST5

The control part 8 refers to the Nlist stored in the memory part 7, and detects the signal strength of the base station having the strongest received signal strength for each communication system in the Nlist. At this time, orders of priority of scanning are determined so that the priority order becomes higher for the base station of the communication system having a stronger signal strength where a difference of signal strengths is 5 dB or more. Namely, for example, in the example of the Nlist shown in FIG. 4, the signal strength of the base station with the 2 GHz band is −1 dB, and the strongest received signal strength among the base stations with the 800 MHz band is −8 dB, therefore the control part 8 sets the priority order of scanning highest for the base station with the 2 GHz band, and sets the priority order lower than the former for the base station of 800 MHz, and proceeds to step ST9.

Note that, when the difference between the strongest received signal strength among the base stations with the 800 MHz band and the strongest received signal strength among the base stations with the 2 GHz band is less than 5 dB, the routine proceeds to step ST6 without setting the priority order in the processing of the present step.

Step ST6

When not setting the priority order at step ST5, the control part 8 refers to the Nlist stored in the memory part 7 and sets the priority order of scanning high for a base station having a small “AGE” value (near 0, that is, it could be communicated with up to just recently) for each of the base stations in the Nlist. Namely, in the priority order set at steps ST4 and ST5, it is not determined which base station of the communication system has a higher priority order, therefore the priority order of the plurality of base stations in the same communication system is not set.

At step ST6, the priority order of the plurality of base stations in the same communication system is set according to the value of “AGE”.

Step ST7

At step ST6, when there are base stations having the same “AGE” value in the same communication system, the routine proceeds to step ST8 without setting the priority order, while when there aren't, the routine proceeds to step ST9.

Step ST8

The control part 8 refers to the Nlist stored in the memory part 7 to set the priority order of scanning high for a base station having a large “window” value for each of the base stations in the Nlist. Namely, the control part sets the priority order according to the size of the “window” for base stations for which the priority order has not been set.

Note that, the window size is a value showing the length of the correlation attempt duration of PN codes used as spread spectrum codes between the base stations and the mobile phone 100 and shows the duration of monitoring the code train on the pilot channel of PN codes.

In a case where the base stations for which the priority order has not yet been set have the same sizes of windows, the priority order of these base stations may be set, for example, at random.

Step ST9

The control part 8 determines the order of scanning for the “in-area” reset so as to perform the scanning based on the priority order set at steps ST4 to ST8 so that the scanning is carried out earlier for a base station having a high priority order and the scanning is carried out later for a base station having a low priority order.

Step ST10

The control part 8 performs the scanning for the “in-area” reset for base stations in the Nlist in the order determined at step ST9.

Step ST11

The control part 8 detects a base station which can be communicated with by scanning for the “in-area” reset at step ST10, ends the in-area reset processing in a case where the communication is carried out with that base station within a predetermined time from detection of the out-of-service-area state at step ST1 and the call ready state can be entered, and proceeds to step ST12 in another case, that is, a case where a base station which can be communicated with cannot be detected by the scanning for the “in-area” reset processing or a base station which can be communicated with cannot be detected within a predetermined duration from the time of the detection of “out of area” state at step ST1 even if the base station can be detected.

Note that, in the case where a base station which can be communicated with cannot be detected by the scanning for the “in-area” reset or a base station which can be communicated with cannot be detected within a predetermined duration from the time of the detection of “out of area” state at step ST1 even if a base station which can be communicated with can be detected, the routine may return to step ST4 in place of proceeding to step ST12 and repeat the setting of the priority order of scanning for the in-area reset again.

Step ST12

The control part 8 performs the scanning for the “in-area” reset by a priority order not based on the Nlist. The control part 8, for example, alternately scans a base station with the 800 MHz band and a base station with the 2 GHz band or determines an order of scanning at random.

Note that, for the priority order of the Nlist, examples were shown of setting the order on the 800 MHz side high at step ST4 and the order on the 2 GHz side high at step ST5. These examples only show examples of processing in such single steps.

In the in-area reset processing of the mobile phone 100 of the present embodiment, the order of performing the scanning for the in-area reset by the control part 8 is determined based on the newest Nlist which is updated before the out-of-service-area state is entered as explained above.

Summarizing the above, in the mobile phone 100 of the present embodiment, the control part 8 sets the priority order of the scanning for the in-area reset according to four processing contents of the following (Processing 1) to (Processing 4) and determines the order of the scanning for the “in-area” reset according to the priority order.

(Processing 1) The control part 8 sets the priority order of the base stations of the communication system having a larger number of base stations among the base stations in the Nlist higher.

(Processing 2) In the case where there is 5 dB or more difference between the signal strength of the base station having the strongest received signal strength among base stations of any communication system and the signal strength of the base station having the strongest received signal strength among base stations of another communication system, the priority order of the base stations of the communication system to which the base station having the strongest received signal strength belongs is set high.

Note that, in a case where the priority order set at (Processing 2) is different from the priority order set at (Processing 1), the priority order set at (Processing 2) is given priority. Namely, the priority order set at (Processing 1) is overwritten by the priority order set at (Processing 2).

(Processing 3) In the priority orders set at (Processing 1) and (Processing 2), the priority order among base stations of the same communication systems is not set. For this reason, at (Processing 3), paying attention to the “AGE” of the Nlist, the control part 8 sets the priority order of the base station having an “AGE” near 0, that is, which has been able to be communicated with up to just recently, high.

(Processing 4) At (Processing 3), when there are base stations having the same “AGE” value of the Nlist, the control part 8 sets the priority order of a base station having a larger “window size” of the Nlist higher for those base stations.

Note that, the processing content of (Processing 1) corresponds to step ST4 of the flow chart shown in FIG. 3 explained above, (Processing 2) corresponds to step ST5, (Processing 3) corresponds to step ST6, and (Processing 4) corresponds to step ST8.

A concrete example will be mentioned.

For example, when the priority order of base stations in the Nlist shown in FIG. 4 is set, first, according to the processing content of (Processing 1), (number of base stations with 800 MHz band):(number of base stations with 2 GHz band)=4:1, therefore the priority order of the base stations with the 800 MHz band is set high.

Next, according to the processing content of (Processing 2), the signal strength of the base station having the strongest received signal strength among the base stations with the 800 MHz band is −8 dB, the signal strength of the base station having the strongest received signal strength among the base stations with the 2 GHz band is −1 dB, and the difference between these two exceeds 5 dB, therefore the priority order of a base station with the 2 GHz band is set higher than that of a base station with the 800 MHz band. Here, the priority order set at (Processing 2) differs from the priority order set at (Processing 1), therefore the priority order set at (Processing 2) is given priority, and the priority order by which a base station with the 2 GHz band is set higher than that of a base station with the 800 MHz band is overwritten over the priority order set at (Processing 1).

Next, according to the processing content of (Processing 3), the priority order of the plurality of base stations with the 800 MHz band is set relative to each other. In this example, the “AGE” of a base station 11 is 3, the “AGE” of a base station 12 is 0, the “AGE” of a base station 13 is 3, and the “AGE” of a base station 15 is 2, therefore the priority order of the base stations with the 800 MHz band relative to each other is set so that base station 12>base station 15>base station 11=base station 13.

According to the processing content of the (Processing 3), the priority order between the base station 11 and the base station 13 has not yet been determined, therefore the priority order of these is determined according to the processing content of the (Processing 4). In this example, the “window size” of the base station 11 is 100, and the “window size” of the base station 13 is 50, therefore the priority order of the base station 11 is set higher than that of the base station 13.

As described above, at the time of the in-area reset processing of the mobile phone 100 of the present embodiment, in the example of the Nlist shown in FIG. 4, the priority order of scanning for the in-area reset is set by the control part 8 so that base station 14>base station 12>base station 15>base station 11>base station 13.

As explained above, according to the mobile phone 100 of the present embodiment, when detecting the out-of-service-area state and performing the in-area reset processing (scanning and detecting a base station which can be communicated with) for reset to the in-area state (call ready state), the order is determined and the scanning is carried out based on the Neighbor List (list of nearby base stations) which is acquired immediately before the mobile phone 100 entered the out-of-service-area state so that the scanning for the in-area reset is carried out from the base station having the highest possibility of communication, therefore the scanning for the in-area reset can be efficiently carried out. Namely, the possibility of shortening the time required until the base station which can be communicated with can be found from the start of the in-area reset processing becomes higher. As a result, it also becomes possible to save power at the time of the in-area reset processing of the mobile phone 100.

Specifically, for example, when considering a case where the mobile phone 100 is placed in a coin locker made of metal or the like, the mobile phone 100 will be surrounded by a signal obstacle and become out of area when placed in the metal coin locker blocking the signal, but the signal environment will become good when it is taken out of the metal coin locker. In this way, when the signal environment around the mobile phone 100 changes sharply in a short time (for example, the mobile phone 100 is placed in the metal coin locker and taken out immediately after that), it would be convenient if the in-area reset could be performed immediately. However, the in-area reset cannot be performed immediately unless at the timing of the in-area reset acquisition operation. Therefore, a little time ends up being taken until communication becomes possible. However, when the user of the mobile phone 100 has to make a call, the phone becomes possible to efficiently try to make a call even if the phone is judged as “out of area”, therefore in a state not actually out-of-service-area such as in the example where the phone is taken out of the metal coin locker, a send operation can be performed at an early period.

Further, in order to make the reset to “in-area” faster, it is not necessary to perform the restitute acquisition processing by a shorter cycle, therefore an increase of the power consumption at the time of “out-of-service-area” can be prevented as much as possible.

Note that, in the explanation of the above embodiment, for simplification of the explanation, the description was made of PN codes used as spread spectrum codes being given for each base station. However, these PN codes may be an actual PN code train or signals having values capable of specifying an offset amount of PN codes as well.

In general, in CDMA communication, by using PN codes as spread spectrum codes, a plurality of terminals can access one base station. Namely, as the communication path for each base station as well, each communication system is configured so that base stations can be discriminated by the wireless communication terminal according to the PN codes.

In the CDMA 2000_{—}1x scheme, by making offset amounts of the PN codes different, multiplexed access is accomplished. However, there are also cases where the PN codes themselves are made to differ each base station as in a W-CDMA (Wide band-CDMA).

In this way, if the PN codes used as the spread spectrum codes are values for discriminating base stations/sectors, any codes can be used.

The present invention is not limited to the embodiment explained above.

Namely, when working the present invention, a variety of amendments, changes, and replacements may be carried out regarding the components of the embodiment explained above within the technical scope of the present invention or the equivalents thereof. The present invention includes those.

In the embodiment explained above, an explanation was given of the four processing contents of (Processing 1) to (Processing 4) for setting the priority order of the “out of area” scanning of base stations in the Nlist at the time of the “out of area” processing of the control part 8, but the present invention is not limited to which of the four processing contents explained above is given the highest priority.

Namely, in the embodiment explained above, the priority order set according to the processing content of (Processing 1) was overwritten by the priority order according to the processing content of (Processing 2) when that priority order was set. However, in the present invention, these may be vice versa. Namely, first, in the case where there is a 5 dB or more difference of signal strengths of the base stations having the strongest received signal strengths in the communication systems, according to the processing content of (Processing 2), the priority order of the base stations of the communication system to which the base station having stronger received signal strength belongs may be set high, then the priority order set according to the processing content of (Processing 2) may be overwritten by the priority order by which the order of the base stations of the communication system having a larger number of base stations is set higher according to the factors of the (Processing 1).

Further, in the embodiment explained above, as an example, the explanation was given of only two frequency bands of 800 MHz band and 2 GHz band, but the present invention is not limited to the exemplified frequency bands.

At present, in Japan, the Japanese specification 800 MHz band (hereinafter referred to as “the old 800 MHz band”) is being used. There are plans for reorganizing this frequency band to a new 800 MHz band of the global standards and specifications. Note that, the old 800 MHz band and the new 800 MHz band differ in allocation of the frequency bands used for uplink and downlink etc.

The frequency bands which can be handled by the wireless communication terminal of the present invention include the existing frequency band (old 800 MHz), new frequency band (new 800 MHz), and high frequency band (2 GHz).

Further, in the old 800 MHz band and new 800 MHz band, there are a primary channel and secondary channel, therefore the communication systems which can be handled by the wireless communication terminal of the present invention may include a primary channel and a secondary channel of the old 800 MHz band, a primary channel and a secondary channel of the new 800 MHz band, and the 2 GHz band, i.e., five communication systems in total as well. Note that, even in such a case, when determining the order of scanning for in-area reset from among the base stations of the five communication systems, the priority order of scanning for “out of area” reset may be set according to processing contents of (Processing 1) to (Processing 4) explained above to set the order of scanning.

In the above embodiment, the communication systems differed in the frequency band. Further, the explanation was given illustrating pilot channels to which different frequencies are assigned as primary and secondary frequencies among the frequency bands. Further, it was illustrated to perform the acquirement processing of a synchronized channel etc. from the base stations by synchronization with this pilot channel by using codes specifying base stations as well. However, when interpreting the scope of the present invention, the divided frequency bands themselves having the predetermined bandwidths may be interpreted as the communication systems or the synchronization etc. of time-divided time slots may be interpreted as the acquirement processing.

Note that, all of the content of Japanese Patent Application No. 2007-048128 (filed on Feb. 27, 2007) is included in the specification of the present application by reference.

1. A wireless communication terminal for establishing in wireless communication with one base station among a plurality of base stations,
said wireless communication terminal comprising:
a communication part which selects one base station of a communication system with one frequency band among a plurality of communication systems with frequency bands available to this wireless communication terminal and engages in wireless communication with the terminal; and
a control part which performs acquirement processing on the available plurality of communication systems through the communication part in a state judged as an out-of-service-area state in which the wireless communication terminal cannot communicate and performs in-area reset processing so as to start position registration processing at one base station using one communication system which could be acquired during which the terminal sets an acquirement sequence of communication systems based on neighbor base station information showing information concerning neighboring base stations which had been acquired by the communication part from base stations for which wireless communication had been established before the wireless communication terminal shifted out of area.

2. A wireless communication terminal as set forth in claim 1, wherein the control part determines the acquirement sequence of communication systems in accordance with a quantity of base stations using communication systems included in the neighbor base station information.

3. A wireless communication terminal as set forth in claim 2, wherein in a case where there are a plurality of base stations using the acquired communication systems, the control part determines the acquirement sequence of base stations using the acquired communication systems in accordance with a magnitude of a received signal strength for each base station measured by the communication part before the wireless communication terminal shifted out of area.

4. A wireless communication terminal as set forth in claim 2, wherein
the wireless communication terminal further comprises a memory part holding information identifying base stations specified by the neighbor base station information, and,
when there are a plurality of base stations using the acquired communication systems, the control part determines the acquirement sequence of base stations using the acquired communication systems in accordance with relative age of the times at which the memory part held the information specifying the base stations.

5. A wireless communication terminal as set forth in claim 2, wherein when there are a plurality of base stations using the acquired communication systems, the control part determines the acquirement sequence of the base stations based on information concerning the relative length of correlation attempt periods of spread spectrum codes included in the neighbor base station information.

6. An in-area reset processing method of a wireless communication terminal establishing in wireless communication with one base station among a plurality of base stations,
said in-area reset processing method of a wireless communication terminal performing acquirement processing on an available plurality of communication systems through a communication means in a state judged as an out-of-service-area state in which the wireless communication terminal cannot communicate and performing in-area reset processing so as to start position registration processing at one base station using one communication system which could be acquired during which setting an acquirement sequence of communication systems based on neighbor base station information showing information concerning neighboring base stations which had been acquired by the communication means from base stations for which the wireless communication had been established before the wireless communication terminal shifted out of area.

7. An in-area reset processing method as set forth in claim 6, further comprising determining the acquirement sequence of communication systems in accordance with a quantity of base stations using communication systems included in the neighbor base station information.

8. An in-area reset processing method as set forth in claim 6, further comprising, where there are a plurality of base stations using the acquired communication systems, determining the acquirement sequence of base stations using the acquired communication systems in accordance with a magnitude of a received signal strength for each base station measured by the communication means before the wireless communication terminal shifted out of area.

9. An in-area reset processing method as set forth in claim 7, further comprising, where there are a plurality of base stations using the acquired communication systems, determining an acquirement sequence of base stations using the acquired communication systems in accordance with an age of time of holding the information identifying the base stations specified by the neighbor base station information.

10. An in-area reset processing method as set forth in claim 7, further comprising, where there are a plurality of base stations using the acquired communication systems, determining the acquirement sequence of the base stations based on information concerning the length of a correlation attempt duration of spread spectrum codes included by the neighbor base station information.

11. A wireless communication terminal comprising a communication part and a control part, and establishing in wireless communication with one base station among a plurality of base stations,
said wireless communication terminal characterized in that
the communication part is configured to select one base station of one communication system among a plurality of communication systems available to the wireless communication terminal and engage in wireless communication with the terminal, and
the control part is configured to perform acquirement processing on the available plurality of communication systems through the communication part in a state judged as an out-of-service-area state in which the wireless communication terminal cannot communicate and performs in-area reset processing so as to start position registration processing at one base station using one communication system which could be acquired during which the terminal sets an acquirement sequence of communication systems based on neighbor base station information showing information concerning neighboring base stations which had been acquired by the communication part from base stations for which wireless communication had been established before the wireless communication terminal shifted out of area.
